(19) United States
(12) Patent Application Publication
(10) Pub. No.: US 2024/0277561 A1
(43) Pub. Date: Aug. 22, 2024

(54) MOTION SENSING MASTURBATION DEVICE WITH VIDEO FEEDBACK

(71) Applicant: WEB FOX TECHNOLOGY, LLC, St. Pete Beach, FL (US)

(72) Inventor: Vivien Cambridge, Myrtle Beach, SC (US)

(73) Assignee: WEB FOX TECHNOLOGY, LLC, St. Pete Beach, FL (US)

(21) Appl. No.: 18/443,840

(22) Filed: Feb. 16, 2024

Related U.S. Application Data
(60) Provisional application No. 63/446,188, filed on Feb. 16, 2023.

(51) Int. Cl. A61H 19/00

(52) U.S. Cl. CPC A61H 19/44; A61H 2201/501; A61H 2201/5043; A61H 2201/5058

(57) ABSTRACT

A masturbation device can include a masturbation component that is a soft material which soft material has an orifice for penetration in a process of masturbation. The masturbation device can further include a processing component, a software component, a movement sensing component, a storage component, a transmission component, and a display component. The masturbation device can also include a physical adapter means for physically attaching the processing, sensing, storage, transmission, and display components to the masturbation component. The software component can be configured to cause transmission of data that is related to movement of the masturbation device to connected processors.

### CROSS REFERENCE TO RELATED APPLICATIONS

This application claims the benefit of U.S. Provisional Application No. 63/446,188 filed on Feb. 16, 2023, and entitled “MOTION SENSING MASTURBATION DEVICE WITH VIDEO FEEDBACK”, which is incorporated by reference as if fully set forth.

### TECHNICAL FIELD

The present invention is related to male masturbation devices. More specifically, the present invention includes a detection component, a software component, a transmission component, and a display component for a masturbation device, which components adds the capability of the hand held masturbation device to process and display user's physical input data.

### BACKGROUND OF THE INVENTION

Many current male masturbation devices comprise a hard outer shell as generally described in a series of patents to Steve Shubin (U.S. Pat. Nos. 5,782,818, 5,807,360). These devices include an elastomeric gel that in its tactile properties resembles human flesh and is molded to visually resemble various human orifices. The gel is often enclosed by a hard shell which serves to allow easier and more comfortable grasping of the device.

The present art includes masturbation devices wherein data related to the insertion of the male sex organ into the masturbator is generated by measuring the movement of the device as it is in use. Movement is usually measured through sensors such as accelerometers and gyroscopes. Since the change in position of the device relative to the body of the user may relate to changes in penetration into the device, this data can be used in software to control games, interactive movies, or to connect counterpart devices that move in concert with the user's action and that may be located at remote locations.

There are also penetration measuring devices in the present art that measure the penetration into the masturbator in a more direct way through the use of capacitive touch sensors or pressure sensors that are dispersed along the longitudinal axis of the masturbator. The sensors measure the approximate location of the penis in the orifice of the device by measuring the engagement of individual sensors along the longitudinal axis of the masturbator with the penetrating member of the male user. Such capacitive touch sensors and pressure sensors and associated wiring must be dispersed inside the masturbator in proximity to the user's penis. This configuration may cause safety concerns and cause a more complex and costly technical configuration of the masturbation device. The present art furthermore includes a device that measures fluctuations in pressure in the masturbator's shell that result from penetration and withdrawal.

Such pressure sensing devices in the present art seal the masturbator to the outside air so that air is trapped inside the shell. As the user penetrates the shell the air inside the shell is compressed and the pressure of that air rises.

All the devices of the present art include the requirement that physical action is modulated into a form of electronic data that is transmitted to a remote processor or a game. This data may or may not be an accurate representation of the user's intentions or of the physical touch feedback that the user is experiencing.

The devices of the present art that are so able to measure movement are not capable of providing instantaneous feedback of measured movement to the user. Such instantaneous feedback could, for example, be a graphical representation of penetration in the form of an elongated object entering a cavity. This feedback would tell the user important details about the data that he is transmitting to the associated games or connected devices. For example, the onset and cessation of movement as determined by the processing software, the rhythm of movement, depth of movement, and other factors could be instantaneously and efficiently observed by the user on the masturbation device itself. This enhances the interactive session as the user engages games or connects to remote devices. As such, there is a need for an improved masturbation device that overcome the issues of previous masturbation devices.

### SUMMARY OF THE INVENTION

According to one aspect, the present disclosure is related to a masturbation device. The masturbation device can include a masturbation component that is a soft material which soft material has an orifice for penetration in a process of masturbation; a processing component, a software component, a movement sensing component, a storage component, a transmission component, and a display component; and a physical adapter means for physically attaching the processing, sensing, storage, transmission, and display components to the masturbation component, the software component causes transmission of data that is related to movement of the masturbation device to connected processors.

In one aspect, the software component causes transmission of data that is related to movement of the masturbation device to connected processors for use in a game.

In one aspect, the software component causes transmission of data that is related to movement of the masturbation device to connected processors to actuate connected devices.

In one aspect, the software component generates image data related to the movement of the masturbation device, and wherein the software component causes display of said image data on the display component of the masturbation device.

In one aspect, the software component generates image data related to the movement of the masturbation device, and the software component causes display of said image data on the display component of the masturbation device.

In one aspect, the software component receives video data from remotely connected processors, and the software component causes video data from the remotely connected processors to be displayed on the display component of the masturbation device.

According to another aspect, the present disclosure is related to a masturbation device. The masturbation device can include a masturbation component that is a soft material which soft material has an orifice for penetration in a process of masturbation; a processing component, a software component, a movement sensing component, a storage component, a transmission component, and a display component; and a physical adapter means for physically attaching the processing, sensing, storage, transmission, and display components to a hand or a wrist of the hand that is holding the masturbation component, the software component causes transmission of data that is related to movement of the masturbation device to connected processors.

In one aspect, the software component causes transmission of data that is related to movement of the masturbation device to connected processors for use in a game.

In one aspect, the software component causes transmission of data that is related to movement of the masturbation device to connected processors to actuate connected devices.

In one aspect, the software component generates image data related to the movement of the masturbation device, and the software component causes display of said image data on the display component of the masturbation device.

In one aspect, the software component generates image data related to the movement of the masturbation device, and the software component causes display of said image data on the display component of the masturbation device.

According to yet another aspect, the present disclosure is related to a masturbation device. The masturbation device can include a masturbation component that is a soft material which soft material has orifice for penetration in a process of masturbation; a processing component, a software component, a movement sensing component, a storage component, a transmission component, and a display component; and a physical adapter means for physically attaching the processing, sensing, storage, transmission, and display components to a hand or a wrist of the hand holding the masturbation component, the software component causes transmission of data that is related to movement of the masturbation device to connected processors to actuate connected devices, and the software component receives video data from remotely connected processors and the software component causes video data from the remotely connected processors to be displayed on the display component of the masturbation device.

### BRIEF DESCRIPTION OF THE DRAWINGS

The foregoing Summary as well as the following Detailed Description will be best understood when read in conjunction with the appended drawings, which illustrate a preferred embodiment of the disclosure. In the drawings:

FIG. 1 is a schematic illustration of the components of the masturbation device according to the present disclosure.

FIG. 2A is a schematic illustration of a first embodiment of the device of FIG. 1.

FIG. 2B is a schematic illustration of a second embodiment of the device of FIG. 1.

FIG. 3 is a flow chart of the software component of the process of operating the first embodiment of the present disclosure.

FIG. 4 is a flow chart of the software component of the process of operating the second embodiment of the present disclosure.

### DETAILED DESCRIPTION OF THE PREFERRED EMBODIMENTS

Certain terminology is used in the following description for convenience only and is not limiting. The words “front”, “rear”, “upper”, and “lower” designate directions in the drawings to which reference is made. The words “inwardly” and “outwardly” refer to directions towards and away from parts referenced in the drawings. “Axially” refers to a direction along the axis of a shaft or cylindrically shaped component/feature. A reference to a list of items that are cited as “at least one of a, b, or c” (where a, b, and c represent the items being listed) means any single one of the items a, b, or c, or combinations thereof. The terms “generally” and “approximately” are to be construed as within 10% of a stated value or ratio. The terminology includes the words specifically noted above, derivatives thereof, and words of similar import.

The present disclosure relates to a system that is a masturbatory device which system includes means for detecting movement of the device and which system includes means for generating data related to said movement of the masturbatory device. The system furthermore includes means for providing graphical feedback to the user which graphical feedback is related to said data which is related to movement of the masturbatory device. To achieve this graphical feedback to the user the system presented includes a physical receptacle component for the user's member such as an elastomeric gel with an orifice, movement sensing components such as an accelerometer, processing component for computing data related to the masturbatory movements of the user, and software component which performs logic procedures to create data related to masturbatory movements of the user and to create image data related to said masturbatory movement which image data is displayed to the user end to transmit said data to remote processor. In addition, the system has means for transmitting data to remote processors for use in games or for actuating connected devices.

Many of the components necessary to achieve the objective of the present invention are available separately in the current art. For example, there are many different masturbatory devices and the components of processor, display and transmission are conveniently comprised in the standard mobile phone device. There have been instances where a tablet has been attached to a masturbatory device for convenient display of erotic movies. However, the component that generates movement data and transmits this data for use in interactive games or for connecting to remote devices is missing in systems of the present art. Recognizing that it will be convenient to combine existing physical components including the masturbatory device and a mobile phone device and to add the software component of the present invention, the system of the present invention then includes a physical adapter strap that quickly and easily attaches a mobile phone to an existing masturbatory device and the present invention furthermore adds the software component of the present invention to memory storage and data processing means of the mobile phone so as to constitute the preferred embodiment of the present invention.

In an alternate embodiment of the present invention, the system is configured to send movement data to a remotely connected processor where the remotely connected processor uses said movement data to actuate a device and where the remotely connected processor includes means for capturing remote image data, which remote image data may portray a scene that includes the actuated device and which remote image data is transmitted to the device of the present invention where the device of the present invention displays said remote image data.

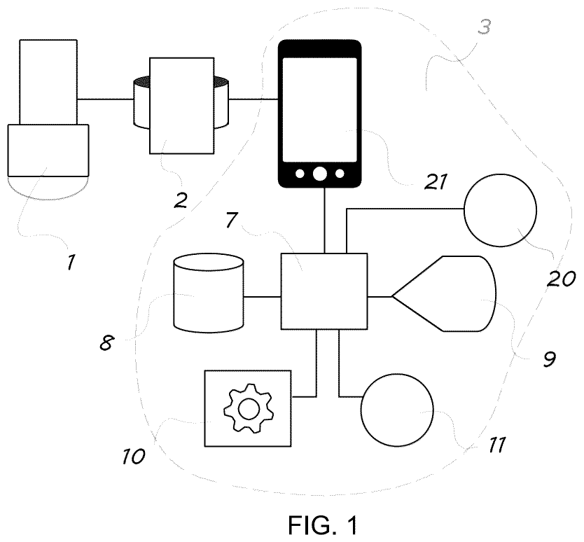

As shown in FIG. 1 the system of the present invention comprises a masturbation component 1 that includes an elastomeric gel with tactile properties of human flesh which elastomeric gel includes an orifice for receiving a penis during masturbation which masturbation component moves in the process of masturbation. The system of the present invention furthermore includes a strap adapter 2, which strap adapter 2 is designed to attach a mobile phone device to the masturbation device 1 so that the mobile phone device moves with the masturbation device 1. The system of the present invention furthermore includes a mobile phone device 3, which mobile phone device 3 comprises a housing 21, a storage means 8 for storing a software component 10, which software component 10 is designed and configured for receiving data from a movement sensing means 20 and for converting data received from the movement sensing means 20 to movement feedback imagery for display on a display device 9, and which processor causes feedback imagery data to be displayed on the display device 9. The software component 10 furthermore computes data suitable for transmission to connected processor for use in games or in other connected devices. The software component 10 sends data related to movement of the masturbation device 1 through a transmission means 11 to a connected processor for use in the games or connected devices.

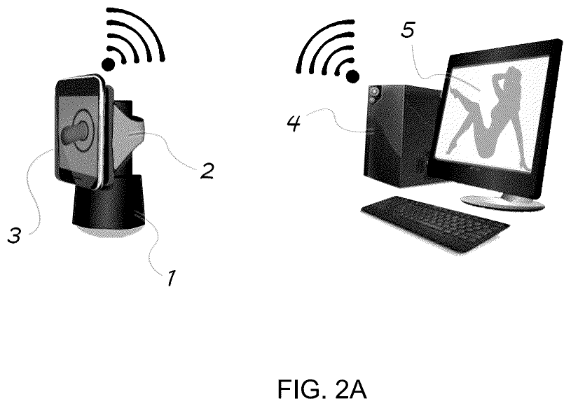

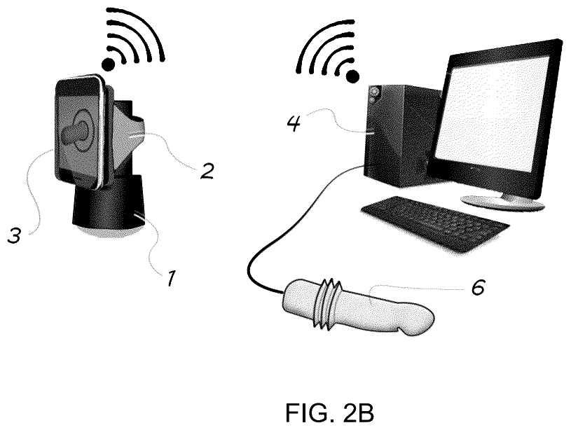

FIG. 2A illustrates a first embodiment of the present invention. As shown in FIG. 2A, the masturbation device 1 attaches to a mobile phone device 3 through the strap adapter 2, which mobile phone device 3 includes the software component 10. The software component 10 causes movement of the masturbator to be visualized through feedback graphic displayed on the display device 9 of the mobile device 3, and the software component 10 causes data related to the movement to be transmitted to the connected processor 4. The movement related data can then be used in games that are displayed on a monitor of the connected processor 4.

FIG. 2B is an illustration of a second embodiment of the device of the present invention in which the system also controls a connected device. As shown in FIG. 2B, the masturbator device 1 attaches to the mobile phone device 3 through the strap adapter 2, which mobile phone device 3 includes the software component 10. The software component 10 causes movement of the masturbator device 1 to be visualized through feedback graphic displayed on the display device 9 of the mobile device 3, and the software component 10 causes data related to the movement to be transmitted to the connected processor 4. The movement related data can then be utilized to actuate the connected device 6 that is controlled by the connected processor 4.

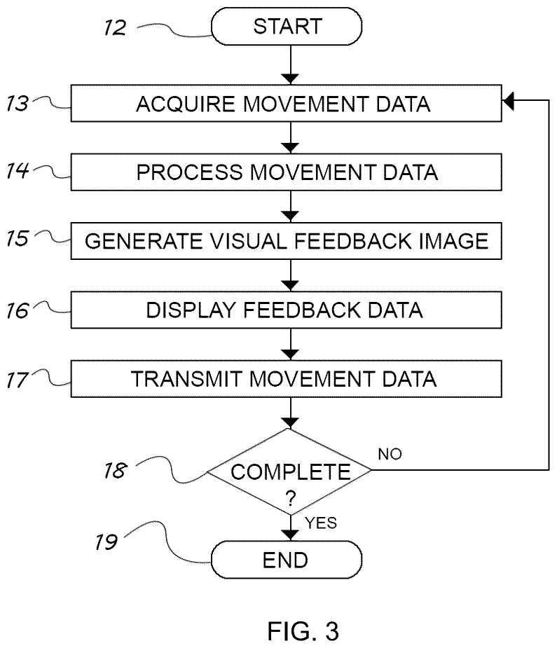

FIG. 3 shows the process of the software component of the first embodiment of the present invention. As shown in FIG. 3, the process commences or starts at step 12 and acquires movement data from a movement sensor at step 13. The movement data is processed at step 14 to generate a visual feedback image at step 15. The generated feedback image is then displayed on the display device 9 of the system at step 16. The system then transmits the movement data to the connected processor at step 17, and then loops to acquire movement data until complete at step 18. The process ends at step 19 upon completion of acquisition of the movement data.

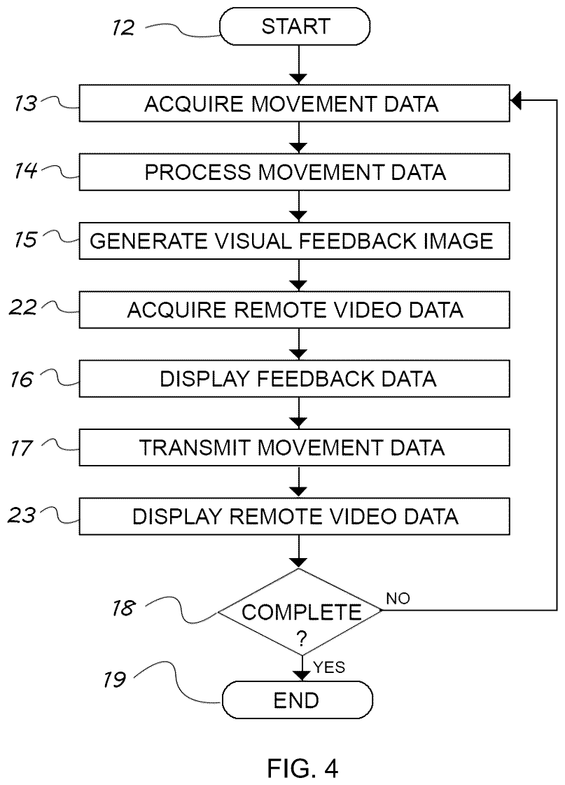

FIG. 4 shows the process flow of the software component of the second embodiment of the present invention, in which the user of the device of the present invention views image data that is augmented with a video stream or images that are received from a remotely connected processor. As shown in FIG. 4, the process of the second embodiment commences or starts at step 12 and acquires movement data from the movement sensor 13. The movement data is processed at step 14 to generate the visual feedback image at step 15. The generated feedback image is then displayed on the display device 9 of the system at step 16. The system then acquires video data at step 22 that portrays the scene at a remotely connected processor, which remotely connected processor receives data from the device of the present invention and actuates an erotic device where the actuation of the erotic device is related to the data received from the device of the present invention. The system of the second embodiment of the present invention transmits the movement data to the remotely connected processor at step 17 and displays the feedback data at step 16 on the display device 9 of the device of the present invention, and augments this feedback data with display of the video image data acquired from the remotely connected processor at step 23. The system of the second embodiment of the present invention loops to acquire movement data until complete at step 18. The process ends at step 19 upon completion of acquisition of movement data.

The present disclosure relates to a device that allows detection of masturbatory movements and that displays feedback data to the user of the device which device also transmits data related to detected movement to connected processor for use in games or to actuate other connected devices.

While two specific embodiments of the invention have been disclosed, other embodiments will be apparent to a person having ordinary skill in the art. For example, it is possible to attach the mobile phone 3 to the masturbation component 1 through the wrist and the hand of the user by attaching adapter 2 to the wrist that is attached to the hand that grasps the masturbation device 1. It is therefore the intention to claim all such embodiments that are variations of the ones presented as within the scope of the invention.

Having thus described the present embodiments in detail, it is to be appreciated and will be apparent to those skilled in the art that many physical changes, only a few of which are exemplified in the detailed description of the disclosure, could be made without altering the inventive concepts and principles embodied therein. It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the disclosure being indicated by the appended claims rather than by the foregoing description, and all alternate embodiments and changes to this embodiment which come within the meaning and range of equivalency of said claims are therefore to be embraced therein.

What is claimed is:

1. A masturbation device comprising:
a masturbation component that is a soft material which soft material has an orifice for penetration in a process of masturbation;
a processing component, a software component, a movement sensing component, a storage component, a transmission component, and a display component; and
a physical adapter means for physically attaching the processing, sensing, storage, transmission, and display components to the masturbation component, wherein the software component causes transmission of data that is related to movement of the masturbation device to connected processors.

2. The masturbation device of claim 1, wherein the software component causes transmission of data that is related to movement of the masturbation device to connected processors for use in a game.

3. The masturbation device of claim 1, wherein the software component causes transmission of data that is related to movement of the masturbation device to connected processors to actuate connected devices.

4. The masturbation device of claim 2, wherein the software component generates image data related to the movement of the masturbation device, and wherein the software component causes display of said image data on the display component of the masturbation device.

5. The masturbation device of claim 3, wherein the software component generates image data related to the movement of the masturbation device, and wherein the software component causes display of said image data on the display component of the masturbation device.

6. The masturbation device of claim 1, wherein the software component receives video data from remotely connected processors, and the software component causes video data from the remotely connected processors to be displayed on the display component of the masturbation device.

7. A masturbation device comprising:
a masturbation component that is a soft material which soft material has an orifice for penetration in a process of masturbation;
a processing component, a software component, a movement sensing component, a storage component, a transmission component, and a display component; and
a physical adapter means for physically attaching the processing, sensing, storage, transmission, and display components to a hand or a wrist of the hand that is holding the masturbation component, wherein the software component causes transmission of data that is related to movement of the masturbation device to connected processors.

8. The masturbation device of claim 7, wherein the software component causes transmission of data that is related to movement of the masturbation device to connected processors for use in a game.

9. The masturbation device of claim 7, wherein the software component causes transmission of data that is related to movement of the masturbation device to connected processors to actuate connected devices.

10. The masturbation device of claim 8, wherein the software component generates image data related to the movement of the masturbation device, and wherein the software component causes display of said image data on the display component of the masturbation device.

11. The masturbation device of claim 9, wherein the software component generates image data related to the movement of the masturbation device, and wherein the software component causes display of said image data on the display component of the masturbation device.

12. A masturbation device comprising:
a masturbation component that is a soft material which soft material has orifice for penetration in a process of masturbation;
a processing component, a software component, a movement sensing component, a storage component, a transmission component, and a display component; and
a physical adapter means for physically attaching the processing, sensing, storage, transmission, and display components to a hand or a wrist of the hand holding the masturbation component, wherein the software component causes transmission of data that is related to movement of the masturbation device to connected processors to actuate connected devices, and wherein the software component receives video data from remotely connected processors and the software component causes video data from the remotely connected processors to be displayed on the display component of the masturbation device.
